(19) United States
(12) Patent Application Publication
(10) Pub. No.: US 2003/0050830 A1
(43) Pub. Date: Mar. 13, 2003

(54) Method and apparatus for evaluating relative performance of a business in an association of the same or similar businesses

(76) Inventor: William Troyer, Stow, OH (US)

Correspondence Address: PPG INDUSTRIES INC, INTELLECTUAL PROPERTY DEPT, ONE PPG PLACE, PITTSBURGH, PA, 15272, US

(21) Appl. No.: 09/952,002

(22) Filed: Sep. 13, 2001

(51) Int. Cl. G06F 17/60

(52) U.S. Cl. 705/11

(57) ABSTRACT

A method of evaluating the business performance of a member such as an automotive collision repair shop in an association of members in the same or similar business. Data on the business performance of the members in the association is maintained in a computer database. The individual member being evaluated electronically submits performance data to the computer containing the database. The data submitted is compared to the data on other association members stored in the database. A report on the comparison is provided back to the individual member.

### BACKGROUND OF THE INVENTION

1. Field of the Invention

The present invention relates to a method and system or apparatus for evaluating the relative performance of a business and, more particularly, to a method and apparatus for comparing the business performance of an automotive collision repair shop to comparable repair shops.

2. Prior Art

An automotive collision repair shop may be an independent shop, a department of an automobile dealership, a franchise facility, or a repair shop for an automobile fleet. The business of operating an automotive collision repair shop requires coordinating the repair work to be done to satisfy a customer and remain efficient and profitable. Particularly for independent repair shops, analysis of the business performance of a collision repair shop is typically not within the expertise of the shop operator.

Accurate analysis of a repair shop's business requires evaluation of factors such as production efficiency, gross profit margin, and sales. To the extent that a collision repair shop possesses some expertise and resources for collecting and tabulating data on its business performance, evaluation of such data remains elusive for most repair shops. Opportunities for improving the business performance of a repair shop may not be recognized or appreciated by the operators of a shop who are involved in the daily operations. Moreover, a typical independent shop operator generally does not have access to information on the business performance of other similar shops that would indicate the productivity of the shop versus other comparable shops.

Accordingly, a need remains for a method and system for analyzing the business performance of a collision repair shop which indicates which aspects of a repair shop's business are performing acceptably in comparison to comparable shops and which aspects of the shop represents opportunities for improvement.

### SUMMARY OF THE INVENTION

This need is met by the method and system or apparatus of the present invention for evaluating the performance of an individual member, such as an automotive collision repair shop, in an association of members in the same or similar businesses, such as individual repair shops, automotive dealerships, shop franchises and fleet repair shops.

In the practice of the method, a central computer is provided which contains a database of performance parameters on the association members. The individual member electronically submits data on its performance to the central computer. The data submitted by the individual member is compared to the data in the database stored in the central computer by software installed on the computer. A report is generated which compares the data submitted by the individual member to the data on the performance of one or more of the association members or to an average or composite measure of performance o the other members. The data submitted by the remote collision repair shop may then be added to the computer database.

A report is generated and may be electronically reported back to the individual member. Besides comparative data, the report may provide recommendations for improving the performance of the individual member.

A complete understanding of the invention as applied to automotive collision repair shops will be obtained from the following description when taken in connection with the accompanying drawing figures wherein like reference characters identify like parts throughout.

### BRIEF DESCRIPTION OF THE DRAWINGS

FIG. 1 is a schematic block diagram of a system according to the present invention for analyzing a collision repair shop's business performance; and

FIG. 2 is a flow diagram of a method of analyzing the business performance of an automotive collision repair shop according to the present invention.

### DESCRIPTION OF THE PREFERRED EMBODIMENTS

The present invention in a particular embodiment relates generally to a method and system or apparatus for evaluating the performance of an automotive collision repair shop. In the following discussion, the method and apparatus are explained with reference to evaluating the performance of an automotive collision repair shop. However, it is to be understood that this exemplary use of the invention should not be considered as limiting. The method and system or apparatus of the invention can be practiced in a variety of fields, such as, but not limited to, automotive glass repair services, and other non-automotive services, such as appliance repair services.

Business Performance Analysis

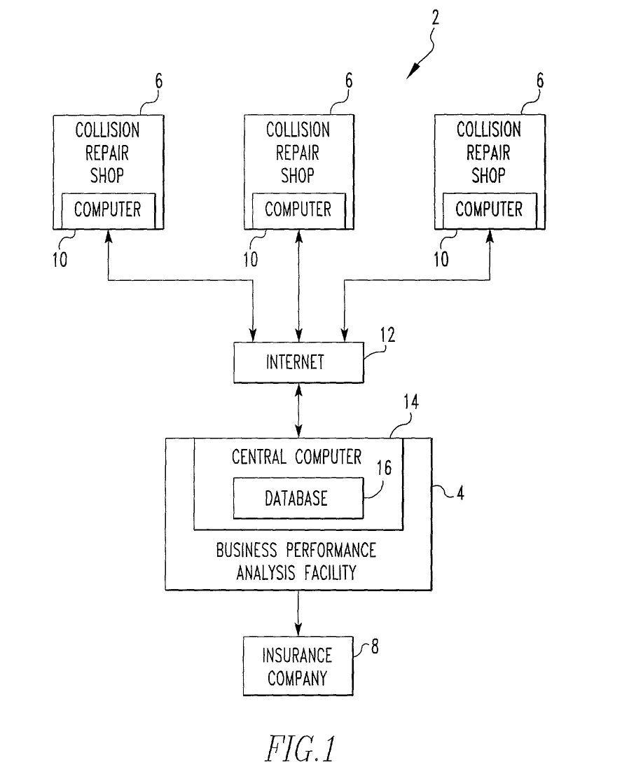

An exemplary collision repair shop business performance analysis system 2 incorporating the features of the invention is schematically shown in FIG. 1. In the exemplary system 2, a business performance analysis facility 4 coordinates the analysis of business performance data from one of a number of collision repair shops 6. The information analyzed by the business performance analysis facility 4 may be provided to an insurance company 8. Each collision repair shop 6 has a computer 10 with a suitable communication device (not shown), such as a modem for communicating with a computer network 12, such as the Internet. The business performance analysis facility 4 likewise includes a central computer 14 with a communication device for communicating with the Internet 12. In this manner, data can be electronically submitted by the collision repair shops 6 to the business performance analysis facility 4. The central computer 14 includes a database 16 containing data on business performance parameters from collision repair shops.

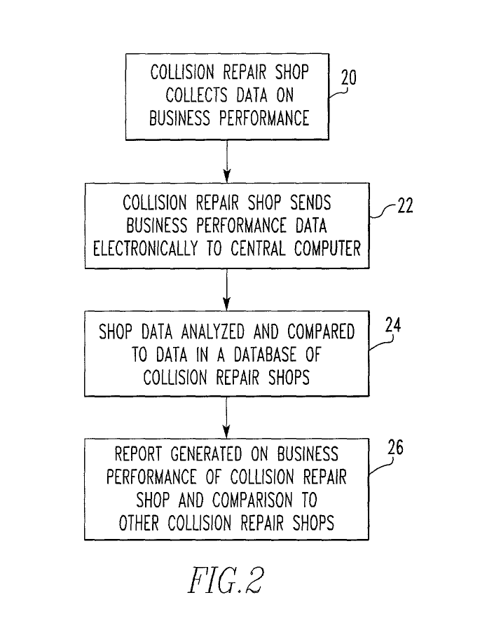

An exemplary method of utilizing the system 2 in the practice of the invention is shown in flowchart format in FIG. 2. In this exemplary method, with reference to FIG. 1 as needed, a collision repair shop 6 collects data on the business performance of the shop in step 20. In step 22, the collision repair shop 6 then sends the business performance data electronically to the central computer 16. Preferably, the collision repair shop 6 inputs the data to the computer 10 and, using the Internet 12, transmits the business performance data to the central computer 14 at the business performance analysis facility 4 by logging onto a web site of the business performance analysis facility 4 and transmitting the data on the business performance of the collision repair shop 6 to the web site of the business performance analysis facility 4. The central computer 14 of the business performance analysis facility 4 downloads the data from the collision repair shop 6 to the central computer 14 for analysis. The central computer 14 receives the data from the collision repair shop 6. The business performance analysis facility 4 then analyzes the submitted data and compares the submitted data to the data in the database of other collision repair shops. Software in the central computer performs the analysis and comparison in step 24. In step 26, the central computer 14 produces a report on the business performance of the collision repair shop that may include a comparison to other similar collision repair shops and/or recommendations for improving the business performance of the repair shop. The report on the collision repair shop's business performance may be electronically transferred back to the collision repair shop 6 in a reverse path or may be printed as a hard copy and delivered to the collision repair shop 6.

The data electronically submitted from a remote collision repair shop 6 is added to the database in the central computer 14 of the business performance analysis facility 4. In this manner, collision repair shop businesses performance data is continually updated.

The data submitted by the collision repair shop 6 indicates the type of shop. Exemplary types of collision repair shops are independent repair shops, automobile dealerships, shop franchises, and fleet repair shops. In step 24 comparing the business performance data of the collision repair shop 6 to the data in database 16, the central computer 14 compares the data of the collision repair shop 6 to shops identified in the database which are of the same shop type. This provides a more accurate comparison of the type of business of the collision repair shop 6 undergoing analysis to its market. Alternatively, the business performance data electronically submitted by the collision repair shop 6 may indicate a labor rate for the work performed at the collision repair shop 6. The central computer 14 of the business performance analysis facility 4 may compare the data in the database 16 having the same labor rate as the data submitted by the collision repair shop 6. Comparison of data for a similar labor rate is of particular interest to the insurance industry. Typically, an insurance company imposes a set labor rate for which payment for a particular type of repair work is covered. Accordingly, a collision repair shop would benefit from comparing its business performance for the labor rate for which it is reimbursed by an insurance company to similar labor rates performed by other collision repair shops.

Business Performance Parameters

The business performance data of the collision repair shop and the data stored in the central computer of the business performance analysis facility includes business performance parameters selected from the following parameters: facility information, labor and employment information, overhead information, administrative management procedures, financial information, personnel management procedures, production procedures, use of tools for sales and marketing, and procedures for protecting health and safety of employees in the shop. These parameters are described in turn hereinafter.

Facility information. The shop may be an independent collision repair shop, the repair shop of a dealership, one shop of a franchise of collision repair shops, or a fleet repair shop. The shop location indicates the general geographic area of the collision repair shop. Business performance and market conditions may be affected by the location of the shop. While relocation of an existing shop generally is not an option, the location of a shop may indicate the maximum business performance that could be expected for a certain location.

Business performance parameters on the shop facilities may indicate the type of refinish paint used by the collision repair shop as well as the estimating systems and the management systems installed at the collision repair shop. Other data on the shop facility may include the total amount of production area, the number of administrative staff members, the administrative staff hours (number of hours worked per week and schedule of hours for each week), production staff hours (number of hours worked per week and schedule of hours for each week), number of employees in each of particular work areas, such as sheet metal work stalls, mechanical work stalls, refinish work stalls, including the number of such work stalls and the number of production workers for each work stall. The collision repair shop may further indicate whether there is any use of a customer satisfaction survey.

Labor and employment information. Parameters on labor information may include labor rates for bodywork, paintwork, framework, and mechanical work. The labor rates may be broken down by categories of payment arrangements. Categories of payment arrangements may include direct customer payment, payment by insurance companies, direct repair programs that involve an agreement with an insurance company, warranty repairs, and repairs performed at a dealership (i.e., an internal repair shop). The data may include information on a material allowance for each hour of refinish work performed, the percentage of work which is done on a direct repair program, the average value of a repair order, the average month's total body shop sales including parts, labor, materials, and the like, the average number of hours billed each month, and the average number of vehicles repaired each month.

Data provided on the employees of the collision repair shop include an indication of whether the repair workers are paid at a flat rate, an hourly rate, an hourly rate with a bonus, commission, or salary. Also indicated are any benefits paid, such as taxes, workers compensation, health insurance, uniforms, retirement funds, vacation, and profit sharing.

Labor sales per unit time (such as for a one-month period) are provided and may be broken down by metal shop labor sales, refinish labor sales, and labor sales for other services as well as a total labor sales per unit time. The data also includes the cost of the corresponding sales. The direct sales and costs also include data on the material sales, cost of materials, part sales, cost of parts, and sales of any sublet repairs, and cost of the sublet repairs per unit time.

Overhead information. Additional financial information includes the overhead costs, such as the administrative staff wages and any other overhead costs, such as rent, utilities, administrative salaries, and advertising for the unit time indicated for the direct sales and costs.

Administrative management information. Data on administrative management may include indications of the following: staff participation in daily organizational meetings to discuss current businesses; written administrative steps understandable by employees; efforts to cross-train administrative staff to prevent interruptions in customer service; resources available for training administrative staff; tracking of daily production and sales; ordering of parts by facsimile and including the vehicle identification number therefor; a standard processing system for supplemental billing opportunities; agreement by suppliers for delivery procedures and responsibilities; assembly of all essential documents into a job file jacket; procedures for documenting returned parts; methods of determining how much work to schedule for a repair; a visual method of tracking vehicles through the production process; a checklist of requirements for each insurance company; responsibility of one person for accepting all parts, invoices, and checking invoices for any price increases; and technical training of estimators to prepare the estimates for preparing accurate estimates.

Financial information. For the financial performance of the collision repair shop, the data provided by the collision repair shop may indicate the following information: individual tracking of labor, parts, materials, and sublet repairs; allocation of costs between labor, parts, materials, and sublet repairs; notification of staff by technicians of supplemental billing opportunities; existence of a business plan; comparison of the shop performance against industry standards; knowledge and understanding by the shop owner of the shop's potential; calculation of monthly break-even points; monitoring of administrative staff costs as a percentage of sales; tracking of technician material usage compared to the hours produced; measuring and monitoring a parts to labor ratio; measuring a gross profit per technician hour; measuring the efficiency of the administrative staff; measuring the average repair order for each estimator; performance of job costing on each repair; and tracking past due accounts receivable with an aging report.

Personnel management information. The business performance parameters of personnel management may indicate the following information: familiarity of the employees with company policies and job descriptions; perception by the employees that management has a concerned interest in them as people; formal periodic review of employees with adequate two-way communication; recognition of employees for a job that is performed well; participation of employees in discussions of changes that will affect the employees; opportunities for advancement and professional growth; uniform levels of accountability with no preferential treatment; payment of employees based on a written incentive based plan; employee turnover; posting of sales and productions to allow employees to see progress toward company goals; an organized work environment with clean restroom and breakroom; recognition of employee credentials that is posted for customers to view; empowerment of employees to make decisions on company policies; pride in shop's image in the community; and an apprentice program to develop and train new technicians.

Production management information. Business performance parameters relating to production management may indicate the following: standardized repair procedures that are written and followed by all technicians; communication and appreciation of quality standards by the production staff; use of a detailed work order accompanying every repair; review of the work order with the technician prior to starting repair work; use of inventory and billing methods for small parts, hardware, and supplies; use of a maintenance log for major pieces of equipment; confirmation of part orders for completeness and accuracy before beginning a repair; labeling of parts with work order number and storage of the parts in a designated area; training of technicians in respective job responsibilities; financial incentives for technicians for production performance; measurement of technician efficiency and sharing of the efficiency information with the measured individual or posting of the information; use of portable tool boxes and moveable carts; inspection of work after major steps in a repair process; use of a supplemental sheet attached to the vehicle at all times; and presence of the proper equipment in the shop to do quality work consistently.

Sales and marketing information. The business performance parameters of sales and marketing may include the following information: monitoring of consumer satisfaction to increase repeat and referral business; reselling of a completed job to a customer upon delivery of the completed work; pursuance of direct repair agreements with insurance companies; sales calls on agents, companies, fleet managers, and dealerships; ample parking which is clearly marked and visible from the street; neat and clean reception area and restrooms; greeting of customers properly with eye contact and addressing them by name; measurement of on-time deliveries; tracking of estimates that have been converted to repair orders (a ratio of open orders to closed orders referred to as a close ratio); formal sales training of estimators to increase the close ratio, accountability of customer service representatives for customer satisfaction, financial incentives for performance of sales representatives, methods of educating the customer on the repair process, recording how each prospect learned about the collision repair shop when writing an estimate, and measurement of the effectiveness of each advertising expenditure.

Health and safety information. Health and safety business performance parameters may indicate the following: proper display of OSHA workplace posters; scheduling of safety meetings; first aid supplies in the collision repair shop; compliance with national electrical code in hazardous areas; visible and unobstructed exits posted with proper signs; inspection of fire extinguishers and notation in an inspection log; posting of no smoking signs in a visible area; use of proper protective equipment for technicians in painting areas; explosion proof equipment in mixing and spray areas; availability of Material Safety Data Sheets (MSDS) for all products; training of employees to understand the MSDSs (Material Safety Data Sheets); availability of skin and eye flush stations in spray areas; documentation of hazardous waste hauler including identification number; storage of hazardous waste in approved containers; and proper marking of hazardous waste containers.

Business Performance Report

The business performance data, which is electronically transmitted to the central computer of the business analysis facility, is analyzed for compliance with preferred practices of collision repair shops and is compared to the data of other collision repair shops stored in the database. Software in the central computer 14 manipulates the business performance data provided from a collision repair shop 6 and generates a report on the business performance of the repair shop 6. The report includes information on overall business performance as well as evaluation of the repair shop's production, finance, administration, personnel management, customer satisfaction, and marketing. The summary of business performance includes an indication of total sales volume, total gross profit, total gross profit as a percentage of sales volume, production efficiency, a ratio of the value of parts sold to labor sold, an average repair order value, an average sales per production employee, an annual sales per administrative employee, a customer satisfaction index, and a gross profit per production employee hour. Each of these parameters are preferably set forth in terms of the last time period that the collision repair shop was analyzed for its business performance, the current time period, and a comparison to the average comparable collision repair shop, top 25% performing comparable collision repair shops and top 10% performing comparable collision repair shops listed in the database 16 of the central computer 14.

The average repair order is useful in assessing the type of auto body repair work performed by the collision repair shop. The annual sales per production employee provides a measure of the efficiency of the repair shop's production staff and may be used to calculate staffing needs in a new facility. The annual sales per administrative employee measures the efficiency of the administrative staff.

In the production portion of the report, the gross profit per production employee hour is an overall measure of the performance of the business of the collision repair shop. This measure incorporates production efficiency (hours sold as a percentage of available technician hours), gross profit margin (earned on sales of labor, parts, materials, and sublet repairs), and sales mix. The report may indicate total production employees, total production hours, production employee total available hours per year and total labor hours sold, and a production efficiency percentage. The production portion may indicate practices that are currently performed by the collision repair shop which are recommended as well as practices that are not performed by the collision repair shop which represent opportunities for improving the repair shop.

The financial portion of the report may include a gross profit margin, repair order analysis sales mix, and gross profit contribution. The gross profit margin may be broken down to labor gross profit margin; parts gross profit margin; material gross profit margin; sublet repair gross profit margin; and value of gross profit per production employee hour. An analysis of the repair orders may indicate the total number of repair orders processed; the average hours per repair order; the average repair order value; the average repair order gross profit; and the total gross profit margin. The report on the sales mix includes a breakdown of the labor, parts, materials, and sublet repairs all as a percentage of total sales, parts to labor ratio, and a gross profit per production employee hour. The gross profit contribution includes a breakdown of the profit provided by labor, parts, materials, and sublet repairs. The financial report may also include a listing of the practices performed by the collision repair shop which contribute beneficially to the financial performance of the collision repair shop as well as practices that may represent an opportunity for improving the financial status of the collision repair shop.

The administrative portion of the report indicates the total number of administrative employees, the available hours per administrative employee per year, total available administrative hours, total number of repair orders processed, administrative hours worked per repair order, total sales volume, annual sales per administrative employee, and annual gross profit per administrative employee. The administrative portion of the report may also indicate the practices performed by the collision repair shop which benefit the administrative staffing of the collision repair shop as well as practices that represent opportunities for improvement.

The personnel portion of the report lists the total number of production employees, total annual sales per production employee, ratio of stalls per technician, annual sales per production stall, production area square footage and total sales per production areas.

When a customer satisfaction survey is included in the data provided to the business performance analysis facility, the report may indicate customer satisfaction via an approval rating (percentage) of overall appearance, appearance of parking and reception areas, average of appearance ratings, ratings on courtesy and professionalism, ratings on quality of work received, percentage of customers dissatisfied, percentage of work completed when promised, percentage of vehicles returned to the customer in clean condition, percentage of customers rating the collision shop at a highest level, and an overall rating satisfaction.

Finally, the marketing portion of the report produced by the business performance analysis facility includes a breakdown of the marketing performance by the collision repair shop in terms of advertising, referral customers, repeat customers, location factors, referral by employees, referral by dealers, yellow pages referrals, insurance company referrals, and other sources. The report may indicate practices that are currently performed by the collision repair shop which are beneficial to the marketing of the shop as well as practices which may be implemented to improve the marketing of the collision repair shop.

The report further includes a projection of a one percent improvement in each of the areas of production efficiency, gross profit margin, and parts to labor ratio to demonstrate the potential for increasing gross profit margin for labor, gross profit margin for parts sales, gross profit margin for sublet repairs, sales volume, total gross profit margin, and gross profit per production employee hour. Each of production efficiency, gross profit margin on labor sales, gross profit on parts, gross profit margin on material sales, gross profit margin on sublet repair sales are artificially increased by one percent. The central computer 14 recalculates the increases in gross profits on labor, parts, materials, sublet repairs, and total gross profit. This projected change in gross profits indicates the potential improvement to the repair shop's business with a one percent increase in efficiency.

The report may also include a projection of the repair shop's business performance if the repair shop were to perform at the level of the average repair shop, top 25% performing repair shops and top 10% performing repair shops of database 16. For potential increase of the repair shop being analyzed to the average production efficiency, top 25% production efficiency, and top 10% production efficiency, the report indicates the expected increase in sales and gross profit per production employee hour. Similar expected increases in sales and gross profit per production employee hour are reported for potential increases of the repair shop being analyzed to the average value, top 25% value, and top 10% value of gross profit margin and parts to labor ratio. The report may further indicate projected increases in gross profits on labor, materials, and sublet repairs and gross profit per production employee per hour upon increasing the repair shops capacity, e.g., by adding one employee. Another projection producible in the report is an analysis of profitability, facility, and employee requirements if the repair shop was operated at the efficiency level of the average repair shop, top 25% repair shops, and top 10% repair shops for a constant total sales.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A method of evaluating the performance of an individual member of an association of members in the same or similar business comprising the steps of:
(1) providing a computer database containing performance data on members of the association;
(2) electronically submitting data on performance of the individual member to the computer database of step (1);
(3) evaluating the data submitted in step (2) for compliance with predetermined business performance standards and comparing the data submitted in step (2) with the data in the database of step (1) via software in the computer of step (1); and
(4) reporting the evaluation and comparison of the data performed in step (3) to the individual member.

2. The method of claim 1 further comprising the step of updating the computer database of step (1) with the data submitted in step (2).

3. The method of claim 1 wherein the computer database of step (1) includes data on at least one business performance parameter selected from the group consisting of facilities, labor and employment information, overhead information, administrative management procedures, financial information, personnel management procedures, production procedures, use of tools for sales and marketing, and procedures for protecting health and safety.

4. The method of claim 1 wherein the data submitted in step (2) identifies the particular business of the individual member and step (3) selects data in the database of step (1) of the other association members in the same business as the individual member for comparison to the data submitted by the individual member.

5. The method of claim 1 in which the individual member is an automotive collision repair shop.

6. The method of claim 5 wherein the automotive collision repair shop is selected from the group consisting of an independent repair shop, an automobile dealership, a franchise shop, and a fleet repair shop.

7. The method of claim 1 wherein the data submitted in step (2) identifies a labor rate and step (3) selects data in the database of step (1) of the other association members having the same labor rate as the individual member being evaluated.

8. The method of claim 1 wherein step (4) comprises electronically reporting the comparison made in step (3) to the individual member being evaluated.

9. The method of claim 1 wherein step (4) comprises creating a printed report of the comparison made in step (3).

10. The method of claim 1 wherein step (4) includes providing recommendations to improve the performance of the individual member being evaluated.

11. A method of evaluating the performance of an automotive collision repair shop comprising the steps of:
(1) providing a computer database containing performance data on automotive collision repair shops;
(2) electronically submitting data on performance of an automotive collision repair shop to the computer database of step (1);
(3) evaluating the data submitted in step (2) for compliance with predetermined business performance standards and comparing the data submitted in step (2) with the data in the database of step (1) via software in the computer of step (1); and
(4) reporting the evaluation and comparison of the data performed in step (3) to the automotive collision repair shop of step (2).

12. The method of claim 11 further comprising the step of updating the computer database of step (1) with the data submitted in step (2).

13. The method of claim 11 wherein the computer database of step (1) includes data on at least one business performance parameter selected from the group consisting of facilities, labor and employment information, overhead information, administrative management procedures, financial information, personnel management procedures, production procedures, use of tools for sales and marketing, and procedures for protecting health and safety.

14. The method of claim 11 wherein the automotive collision repair shop of step (2) is a shop type selected from the group consisting of an independent repair shop, an automobile dealership, a franchise shop, and a fleet repair shop.

15. The method of claim 14 wherein the data of the automotive collision repair shops compared in step (3) are for shops of the same shop type as the automotive collision repair shop being evaluated.

16. The method of claim 11 wherein the data submitted in step (2) identifies a labor rate and step (3) selects data in the database of step (1) of automotive collision repair shops having the same labor rate as the automotive collision repair shop being evaluated.

17. The method of claim 11 wherein step (4) comprises electronically reporting the comparison made in step (3) to the automotive collision repair shop being evaluated.

18. The method of claim 11 wherein step (4) includes providing recommendations to improve the performance of the automotive collision repair shop being evaluated.

19. A performance analysis system comprising:
(a) a central computer storing a database containing data on business performance of an association of members in the same or similar businesses;
(b) a remote computer located at an individual member's place of business, said remote computer being electronically communicable with the central computer such that data on performance of the individual member is electronically transferable to said central computer; and
(c) software installed on said central computer for evaluating performance data transferred from said remote computer to said data stored in said database.

20. The system of claim 19 wherein said database includes data on at least one business performance parameter selected from the group consisting of facilities, labor and employment information, overhead information, financial information, administrative management procedures, personnel management procedures, production procedures, use of tools for sales and marketing, and procedures for protecting health and safety.

21. The system of claim 19 wherein said software is configured to identify the particular business of the individual member and to select data in said database of the other association members in the same business as the individual member for comparison to the data submitted by the individual member.

22. The system of claim 19 wherein the members listed in said database are automotive collision repair shops.

23. An automotive collision repair shop performance analysis system comprising:
(a) a central computer storing a database containing data on business performance of automotive collision repair shops;
(b) a remote computer located at a remote automotive collision repair shop, said remote computer being electronically communicable with the central computer such that data on performance of the remote automotive repair shop is electronically transferable to said central computer; and
(c) software installed on said central computer for evaluating performance data transferred from said remote computer to said data stored in said database.

24. The system of claim 23 wherein said database includes data on at least one business performance parameter selected from the group consisting of facilities, labor and employment information, overhead information, financial information, administrative management procedures, personnel management procedures, production procedures, use of tools for sales and marketing, and procedures for protecting health and safety.

25. The method of claim 23 wherein the automotive collision repair shop having said remote computer is a shop type selected from the group consisting of an independent repair shop, an automobile dealerships, a franchise shop, and a fleet repair shop.

26. The method of claim 25 wherein said software is configured to identify the shop type of the automotive collision repair shop having said remote computer and to select data for evaluation in said database of the automotive collision repair shops having the same shop type as the remote automotive collision repair shop.
